(19) United States
(12) Patent Application Publication
(10) Pub. No.: US 2024/0396066 A1
(43) Pub. Date: Nov. 28, 2024

(54) Device for Converting Voltage

(71) Applicants: Kumaran Thirugnanasambandam Kali, Gerlingen (DE); Tobias Keitel, Düsseldorf (DE)

(72) Inventors: Kumaran Thirugnanasambandam Kali, Gerlingen (DE); Tobias Keitel, Düsseldorf (DE)

(73) Assignee: GLOBE Fuel Cell Systems GmbH, Stuttgart (DE)

(21) Appl. No.: 18/667,381

(22) Filed: May 17, 2024

(30) Foreign Application Priority Data
May 22, 2023 (DE) 10 2023 204 720.9

(51) Int. Cl. H01M 8/04858; H01M 8/0432; H01M 8/04664; H01M 8/04955; H01M 16/00; H02J 7/34

(52) U.S. Cl. CPC H01M 8/04888; H01M 8/0432; H01M 8/04671; H01M 8/04955; H01M 16/006; H02J 7/34; H01M 2220/20; H02J 2300/30

(57) ABSTRACT

A device for converting voltage for a drive. The device comprises a first DC voltage converter and a second DC voltage converter. The first DC voltage converter can be set or configured and operated as an inverse converter or as a boost converter.

The drive may be for a forklift truck with a fuel cell system, a battery, at least one electrical element and the device.

### CROSS-REFERENCE TO RELATED PATENT APPLICATIONS

This patent application claims the benefit of priority to German Patent Application No. 102023204720.9, filed May 22, 2023, the entire teachings and disclosures are incorporated herein by reference thereto.

### FIELD OF THE INVENTION

The invention relates to a device for converting voltage for a fuel cell electric drive according to the preamble of claim 1. The invention also relates to the fuel cell electric drive comprising the device.

### BACKGROUND OF THE INVENTION

A fuel cell electric drive, for example for a forklift truck, usually comprises a fuel cell system, a battery and at least one electrical element. In particular, the electrical element can be a so-called BoP element (BoP: Balance-of-Plant) of the fuel cell system—for example a sensor or an actuator or a valve or a pump of the fuel cell system. The fuel cell system provides energy that is stored in the battery and is made available to the electrical elements as required. The fuel cell system, the battery and the electrical elements are designed for different voltages. For example, the fuel cell system usually provides a voltage of 40-80V and the electrical elements are usually operated with a voltage of 24V. Batteries with different nominal voltages—for example 48V, 80V or 96V—can also be installed in the drive. Two DC voltage converters or DC-DC converters are provided in the drive for converting voltages. One DC voltage converter converts the voltage provided by the fuel cell system into the voltage to be provided to the battery of the drive. The other DC voltage converter converts the voltage provided by the battery into the voltage to be provided to the respective element of the drive. Depending on the battery installed, differently designed DC voltage converters are installed in the drive and controlled separately.

### SUMMARY OF THE INVENTION

The object of the invention is therefore to provide an improved or at least alternative embodiment for a device of the type described, in which the disadvantages described are overcome. A further object of the invention is to provide a drive comprising the corresponding device.

According to the invention, this object is achieved by the subject matter of the independent claims. Advantageous embodiments are the subject of the dependent claims.

The present invention is based on the general idea of combining and integrating DC voltage converters for a fuel cell electric drive, in particular for a forklift truck, in a device in such a way that the device can be used independently of the nominal voltage of the installed battery without structural changes in the drive.

The device according to the invention is intended or designed for converting voltage for a fuel cell electric drive. In particular, the drive can be provided for a forklift truck or for driving a forklift truck. The device has a first unit with a first DC voltage converter or a first DC-DC converter and a second unit with a second DC voltage converter or a second DC-DC converter. The first DC voltage converter is designed to convert a first input voltage provided by a fuel cell system of the drive into a first output voltage to be provided to a battery of the drive. The second DC voltage converter is designed to convert a second input voltage provided by the battery of the drive into a second output voltage to be provided to the respective element of the drive. According to the invention, the first DC voltage converter is designed such that it can be set or configured and operated as an inverse converter or in a BUCK-BOOST mode or as a boost converter or in a BOOST mode, depending on the level of the first output voltage to be provided to the battery of the drive.

The first DC voltage converter may be set or configured to operate as an inverse converter or in the BUCK-BOOST mode and to convert the higher first input voltage into the lower first output voltage. The first DC voltage converter can also be set or configured to operate as a boost converter or in the BOOST mode and to convert the lower first input voltage into the higher first output voltage. Accordingly, the device can increase or decrease the first input voltage provided by the fuel cell system and accordingly provide the first output voltage depending on the nominal voltage of the battery of the drive. This means that the device can be installed in the drive with batteries having different nominal voltages. The respective nominal voltage of the installed battery can be higher or lower than the first input voltage provided by the fuel cell system. The first DC voltage converter can be set or configured as an inverse converter or as a boost converter by means of a controller depending on the application or depending on the nominal voltage of the battery installed in the drive. The second DC voltage converter can be designed as a buck converter for converting the second input voltage into the second output voltage or can be operated in BUCK mode.

The first DC voltage converter and the second DC voltage converter are combined and integrated in the device. Thanks to the adjustable or configurable first DC voltage converter, the device can cover several applications on the market and can be used flexibly in fuel cell electric drives with batteries having different nominal voltages. This allows several functions to be integrated in the device and reduces the costs of series production.

The first DC voltage converter may be designed to convert the first input voltage equal to 40-80V to the first output voltage. In other words, the device may be designed for the drive of which the fuel cell system provides a voltage equal to 40-80V. The second DC voltage converter may be designed to convert the second input voltage to the second output voltage equal to 24V. In other words, the device may be designed for the drive of which the respective electrical element is operable at a voltage equal to 24V.

The device may be designed to be powered by the battery with a nominal voltage equal to 96V. The first DC voltage converter may be set or configured as a boost converter for converting the first input voltage to the first output voltage equal to 90-100V, or may be operable in the BOOST mode. The second DC voltage converter may be configured as a buck converter for converting the second input voltage equal to 90-100V into the second output voltage equal to 24V.

The device may be designed to be powered by the battery with a nominal voltage equal to 80V. The first DC voltage converter may be set or configured as a boost converter for converting the first input voltage to the first output voltage equal to 70-100V, or may be operable in the BOOST mode. The second DC voltage converter may be configured as a buck converter for converting the second input voltage equal to 70-100V into the second output voltage equal to 24V.

The device can be designed to be powered by the battery with a nominal voltage equal to 48V. The first DC voltage converter may be set or configured as an inverse converter for converting the first input voltage to the first output voltage equal to 35-60V, or may be operable in the BUCK-BOOST mode. The second DC voltage converter may be configured as a buck converter for converting the second input voltage equal to 35-60V to the second output voltage equal to 24V.

The device can be designed to be powered by batteries with a nominal voltage equal to 48-96V. In particular, the device can be designed to be powered by batteries with a nominal voltage equal to 96V and 80V and 48V. The first DC voltage converter may be designed to convert the first input voltage equal to 40-80V into the first output voltage equal to 35-100V. Accordingly, in the device, the first DC voltage converter may combine the function of voltage conversion from 40-80V to 90-100V and 70-100V and 35-60V. The second DC voltage converter can be designed to convert the second input voltage equal to 35-100V to the second output voltage equal to 24V. Accordingly, in the device, the second DC voltage converter may combine the function of voltage conversion from 90-100V and 70-100V and 35-60V to 24V.

In a possible embodiment of the device, the first unit can have a first controller, preferably a microcontroller, for controlling the first DC voltage converter. The first DC voltage converter can then be set or configured and operated by means of the first controller as an inverse converter or in a BUCK-BOOST mode or as a boost converter or in a BOOST mode. The first DC voltage converter can be controlled by the first controller in such a way that it can be operated in a constant-current mode or in a constant-voltage mode. This means that the battery of the drive can be charged in the constant-current mode or in the constant-voltage mode.

In one possible embodiment of the device, the second unit can have a second controller, preferably a microcontroller, for controlling the second DC voltage converter. The second DC voltage converter can be controlled by means of the second controller in such a way that it immediately starts converting the second input voltage into the second output voltage when the second input voltage is applied.

The device can have a housing and the first unit and the second unit and/or the first DC voltage converter and the second DC voltage converter can be arranged together in the housing. The housing can delimit the first unit and the second unit and/or the first DC voltage converter and the second DC voltage converter from the outside and protect them from external influences. The housing can appropriately have several connections leading to the outside for connecting the first unit and the second unit and/or the first DC voltage converter and the second DC voltage converter to the fuel cell system and/or to the battery and/or to the respective electrical element of the drive.

The first unit and the second unit and/or the first DC voltage converter and the second DC voltage converter can be mapped on a common printed circuit board. In other words, individual components of the first unit and the second unit and/or of the first DC voltage converter and the second DC voltage converter may be fixed on the common printed circuit board and electrically interconnected in each case. The first unit and the second unit and/or the first DC voltage converter and the second DC voltage converter can be electrically isolated from each other. In addition, mutual interference between the first unit and the second unit and/or between the first DC voltage converter and the second DC voltage converter can be prevented or at least reduced.

In one possible embodiment of the device, the first DC voltage converter can have a precharging circuit and/or an input filter circuit and/or a multiphase converter circuit and/or an output filter circuit. The multiphase converter circuit can be controlled by a first controller, preferably a microcontroller, by means of a PWM signal. The precharging circuit, the input filter circuit, the multiphase converter circuit and the output filter circuit can be connected in series with one another in the aforementioned sequence. The aforementioned circuits can be constructed in a manner known to a person skilled in the art.

In one possible embodiment of the device, the second DC voltage converter can have a precharging circuit and/or an input filter circuit and/or a buck converter circuit and/or an output filter circuit. The precharging circuit, the input filter circuit, the buck converter circuit and the output filter circuit can be connected in series with one another in the aforementioned order. The aforementioned circuits can be constructed in a manner known to a person skilled in the art.

The device can have a first circuit breaker and the first circuit breaker can be connected directly downstream of the first DC voltage converter or the first unit. The first circuit breaker can be closed during normal operation of the device and open during exceptional operation of the device. The first circuit breaker can therefore be connected in the drive between the first DC voltage converter or the first unit and the battery. The exceptional operation can occur, for example, if the first DC voltage converter overheats and/or if a limit voltage is exceeded in the first DC voltage converter and/or if there is no signal-transmitting connection between the first DC voltage converter and a controller.

The device can have a second circuit breaker and the second circuit breaker can be connected directly upstream of the second DC voltage converter or the second unit. The second circuit breaker can be closed during normal operation of the device and open during exceptional operation of the device. The second circuit breaker can therefore be connected in the drive between the battery and the second DC voltage converter or the second unit. Exceptional operation can occur, for example, if the second DC voltage converter overheats and/or if a limit voltage is exceeded in the second DC voltage converter and/or if there is no signal-transmitting connection between the second DC voltage converter and a controller.

The second unit and/or the second DC voltage converter can have a third circuit breaker for switching on and off at least one safety-relevant element of the drive. In particular, the third circuit breaker can be integrated into the second DC voltage converter or into a circuit mapping the second DC voltage converter. The third circuit breaker can, for example, be realised by a semiconductor switch or a relay. The third circuit breaker can be designed in such a way that in normal operation the third circuit breaker is closed and the respective element is switched on and in exceptional operation the third circuit breaker is open and the respective element is switched off. Normal operation can be defined when there is a signal-transmitting connection between a controller controlling the fuel cell system of the drive and the second unit. By contrast, exceptional operation can be defined when there is no signal-transmitting connection between the controller controlling the fuel cell system of the drive and the second unit. The signal-transmitting connection between the second unit and the controller controlling the fuel cell system of the drive can be realised, for example, via a CAN bus (CAN: Controller Area Network).

The safety-relevant element of the drive can, in particular, be a safety-relevant valve of the fuel cell system of the drive. The safety-relevant valve can, for example, be designed to supply hydrogen to a fuel cell of the fuel cell system. In normal operation, the valve can then be switched on or opened so that hydrogen can be supplied to the fuel cell. In exceptional operation, on the other hand, the valve can be switched off or closed so that no hydrogen can be fed to the fuel cell. The third circuit breaker can therefore protect the fuel cell of the fuel cell system from an excess of hydrogen, thereby eliminating or at least reducing the risk of explosion in the fuel cell system. This can increase the safety level of the fuel cell system and the drive as a whole.

In one possible embodiment, the device can have a fuse unit for monitoring the operation of the first unit and/or the second unit. The fuse unit can have a unit for temperature monitoring and/or a unit for power monitoring and/or a unit for short-circuit monitoring and/or a unit for overvoltage and undervoltage monitoring and/or a unit for limit current monitoring and/or a unit for interlock monitoring between the fuse unit and the first unit and/or the second unit. The respective unit can expediently have the components required to realise its function—for example sensors. If the device has a common housing for the first unit and the second unit and/or for the first DC voltage converter and the second DC voltage converter, the fuse unit can be arranged in the housing. The housing can appropriately have the connections for contacting the fuse unit to the outside. The fuse unit can increase the safety and reliability of the device.

In one possible embodiment, the device can have a cooling plate through which a cooling fluid can flow. The cooling plate can be connected to the first unit and/or to the second unit and/or to a fuse unit for monitoring the operation of the first unit and/or the second unit heat-transferringly. If the device has a common housing for the first unit and the second unit and/or for the first DC voltage converter and the second DC voltage converter, the cooling plate can be arranged in the housing. The housing can appropriately have the connections for supplying and discharging the cooling fluid to the cooling plate. In particular, the cooling fluid can be a liquid. In particular, the liquid can be a water-glycol mixture. The cooling plate can be used to cool the first unit and/or the second unit and/or the fuse unit, thereby eliminating or at least reducing the risk of overheating.

The invention also relates to a fuel cell electric drive with a fuel cell system, a battery, at least one electrical element and the device described above. The drive can be designed in particular for a forklift truck or for driving a forklift truck or generally for generating energy for different applications. The fuel cell system, the battery, the respective electrical element and the device are electrically interconnected. The first input voltage for the first DC voltage converter of the device can be provided by the fuel cell system and the second input voltage for the second DC voltage converter of the device can be provided by the battery. Furthermore, the first output voltage of the first DC voltage converter can be provided for charging the battery and the second output voltage of the second DC voltage converter can be provided for operating the respective electrical element. In other words, the first unit or the first DC voltage converter is electrically connected on the input side to the fuel cell system and on the output side to the battery, and the second unit or the second DC voltage converter is electrically connected on the input side to the battery and on the output side to the respective element.

The fuel cell system can comprise a fuel cell and other BoP elements (BoP: Balance-of-Plant)-such as sensors or actuators or valves or pumps. The respective BoP element of the fuel cell system can represent the respective element of the drive. The respective element of the drive or the respective BoP element of the fuel cell system can be designed in particular for operation with a voltage equal to 24V. The fuel cell of the fuel cell system can have several individual cells and can be designed to provide a voltage equal to 40-80V. In particular, the battery of the drive can be a lithium-ion battery. The battery of the drive can have a nominal voltage equal to 48V-96V. In particular, the battery of the drive can have a nominal voltage equal to 48V or 80V or 96V. The device can be designed for the drive with the batteries having a nominal voltage equal to 48-96V. In particular, the device can be designed for the drive with the batteries with a nominal voltage equal to 96V and 80V and 48V. The first DC voltage converter may be designed to convert the first input voltage equal to 40-80V to the first output voltage equal to 35-100V. The second DC voltage converter may be designed to convert the second input voltage equal to 35-100V into the second output voltage equal to 24V. In order to avoid further repetition, reference is made at this juncture to the above explanations.

Further important features and advantages of the invention can be found in the dependent claims, in the drawings and in the associated description of the figures with reference to the drawings.

It is understood that the above-mentioned features and those to be explained below can be used not only in the combination indicated in each case, but also in other combinations or on their own, without departing from the scope of the present invention.

Preferred exemplary embodiments of the invention are shown in the drawings and are explained in greater detail in the following description, with like reference signs referring to like or similar or functionally like components.

### BRIEF DESCRIPTION OF THE DRAWINGS

The drawings show, schematically in each case:

FIG. 1 shows a block diagram of a device according to the invention for a fuel cell electric drive;

FIG. 2 shows a block diagram of a drive according to the invention comprising the device according to the invention;

FIG. 3 shows a block diagram of the drive according to the invention with the device according to the invention and a battery with a nominal voltage equal to 96V;

FIG. 4 shows a block diagram of the drive according to the invention with the device according to the invention and a battery with a nominal voltage equal to 80V;

FIG. 5 shows a block diagram of the drive according to the invention with the device according to the invention and a battery with a nominal voltage equal to 48V; and

FIG. 6 shows a further block diagram of the drive according to the invention comprising the device according to the invention.

### DETAILED DESCRIPTION OF THE INVENTION

FIG. 1 shows a block diagram of a device 1 according to the invention for a fuel cell electric drive 2. The drive 2 can be designed in particular to drive a forklift truck.

The device 1 comprises a first unit 3a with a first DC voltage converter 4a. The DC voltage converter 4a is designed to convert a first input voltage U1_IN into a first output voltage U1_OUT, as indicated by solid arrows. The first DC voltage converter 4a can be set or configured as an inverse converter and as a boost converter and can be operated accordingly in a BUCK-BOOST mode and in a BOOST mode.

Furthermore, the device 1 comprises a second unit 3b with a second DC voltage converter 4b. The second DC voltage converter 4b is designed to convert a second input voltage U2_IN into a second output voltage U2_OUT, as indicated by solid arrows. The second DC voltage converter 4b is designed as a step-down converter. The first output voltage U1_OUT can correspond to the second input voltage U2_IN. However, a direct connection between the first DC voltage converter 4a and the second DC voltage converter 4b is not provided.

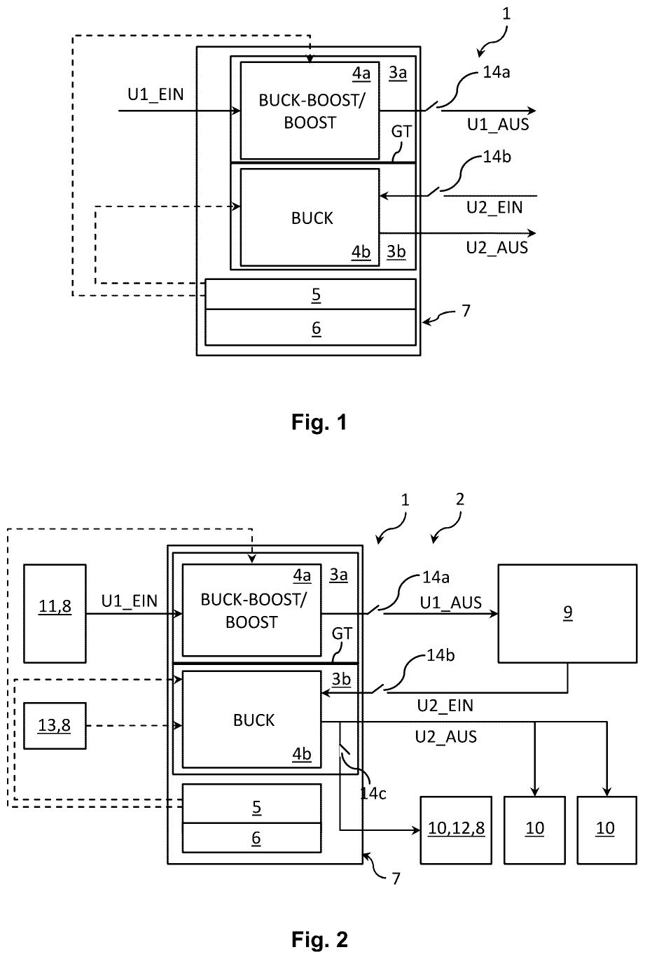

The device 1 also comprises a first circuit breaker 14a, which is connected directly electrically downstream of the first DC voltage converter 4a or the first unit 3a. The device 1 also comprises a second circuit breaker 14b, which is connected directly electrically upstream of the second DC voltage converter 4b or the second unit 3b. The function of the two circuit breakers 14a and 14b is explained in greater detail below with reference to FIG. 2 to FIG. 5. The first unit 3a and the second unit 3b are galvanically isolated from each other by means of galvanic isolation GT. This prevents or at least reduces unwanted interactions or mutual interference between the two units 3a and 3b.

The device 1 also has a safety unit 5 for monitoring the operation of the first unit 3a and the second unit 3b. For this purpose, the fuse unit 5 is connected accordingly to the first unit 3a and to the second unit 3b—as indicated by broken lines. In particular, the fuse unit 5 can monitor a temperature and/or a power and/or a short circuit and/or an overvoltage and undervoltage and/or a limit current and/or an interlocking between the fuse unit 5 and the first unit 3a and/or the second unit 3b.

In addition, the device 1 comprises a cooling plate 6 through which a cooling fluid—in particular a liquid such as a water-glycol mixture—can flow. The cooling plate 6 is expediently connected to the first unit 3a and/or to the second unit 3b and/or to the fuse unit 5 heat-transferringly. This allows the first unit 3a and/or the second unit 3b and/or the fuse unit 5 to be cooled and protected from overheating.

The device 1 also has a common housing 7 for the first units 3a and 3b, the fuse unit 5 and the cooling plate 6. The housing 7 can expediently have corresponding connections for the first and second units 3a and 3b, possibly corresponding connections for the fuse unit 5 and possibly corresponding connections for supplying and discharging the cooling fluid to the cooling plate 6.

FIG. 2 shows a block diagram of the drive 2 according to the invention with the device 1 according to the invention. In addition to the device 1, the drive 2 has a fuel cell system 8, a battery 9 and several electrical elements 10, only three of which are shown here by way of example. The fuel cell system 8 comprises a fuel cell 11, a safety-critical valve 12, which is also one of the electrical elements 10 of the drive 2, and a controller 13 for controlling the fuel cell system 8. The further electrical elements 10 of the drive 2 can be sensors and/or actuators of the drive 2 and/or of the fuel cell system 8. In particular, the battery 9 can be a lithium-ion battery.

The fuel cell 11 provides the first input voltage U1_IN for the first DC voltage converter 4a. The first DC voltage converter 4a converts the first input voltage U1_IN into the first output voltage U1_OUT. In doing so, the first DC voltage converter 4a can increase the first input voltage U1_IN in the BOOST mode or reduce the first input voltage U1_IN in a BUCK-BOOST mode. The first output voltage U1_OUT is then provided to the battery 9 for charging. The battery 9 then provides the second input voltage U2_IN to the second DC voltage converter 4b. The second DC voltage converter 4b converts the second input voltage U2_IN into the second output voltage U2_OUT. The second DC voltage converter 4b can be operated in BUCK mode and reduces the second input voltage U2_IN. The second output voltage U2_OUT is then provided to the elements 10 of the drive 2.

The second unit 3b of the device 1 also has a third circuit breaker 14c for switching on and off one of the electrical elements 10 of the drive 2—in this case the safety-relevant valve 12 of the fuel cell system 8. The third circuit breaker 14c can in particular be integrated in the second DC voltage converter 4b or in the second unit 3b and can be realised, for example, as a semiconductor switch or a relay. In normal operation, the third circuit breaker 14c is closed and the valve 12 is switched on or open, and in exceptional operation the third circuit breaker 14c is open and the valve 12 is switched off or closed. The valve 12 can, for example, be designed to supply hydrogen to the fuel cell 11 of the fuel cell system 8. In normal operation, the valve 12 is then open so that hydrogen can be supplied to the fuel cell 11. In exceptional operation, however, the valve 12 is closed so that no hydrogen can be fed to the fuel cell 11. This can prevent an excess of hydrogen being produced in the fuel cell 11 of the fuel cell system 8 during exceptional operation.

Due to the adjustable or configurable first DC voltage converter 4a, the device 1 can be used in the drives 2 with batteries 9 with different nominal voltages. For example, the fuel cell system 8 can provide a voltage equal to 40-80V. The battery 9 can have a nominal voltage equal to 48-96V. In particular, the battery 9 can have a nominal voltage equal to exactly 48V or exactly 80V or exactly 96V. The respective electrical elements 10 can be operated with a voltage equal to 24V. The first DC voltage converter 4a of the device 1 can then convert the first input voltage U1_IN equal to 40-80V in the BOOST mode or in the BUCK-BOOST mode into the first output voltage U1_OUT equal to 35-100V, depending on the battery 9 installed in the drive 2. The second DC voltage converter 4b can then convert the second input voltage U2_IN equal to 35-100V in BUCK-BOOST mode into the second output voltage U2_OUT equal to 24V.

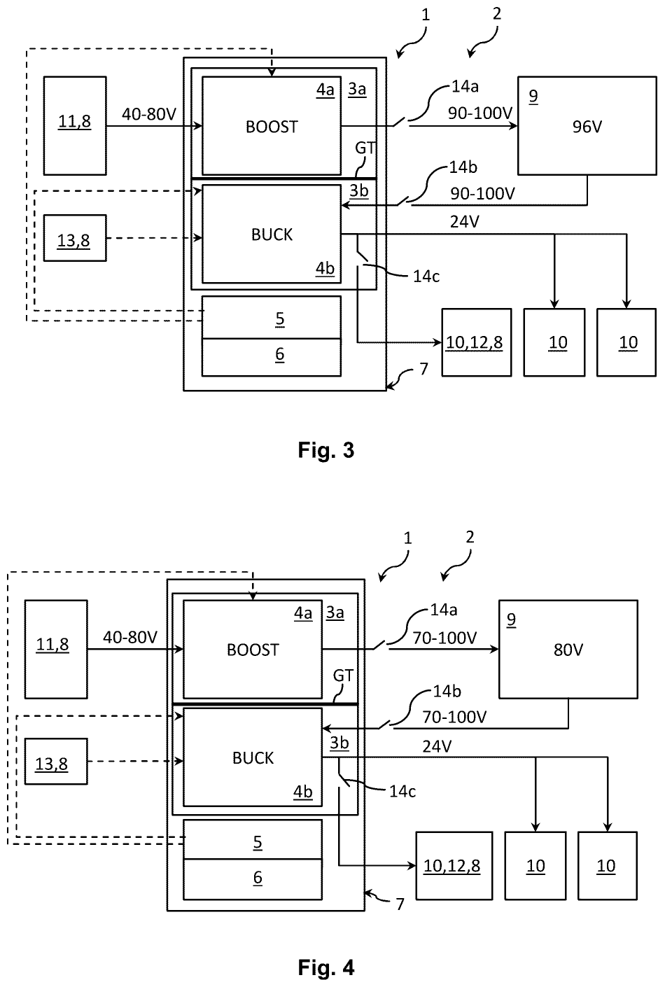

FIG. 3 shows a block diagram of the drive 2 according to the invention with the device 1 according to the invention and the battery 9 with a nominal voltage equal to 96V. Here, the first DC voltage converter 4a is configured or set in such a way that it converts the first input voltage U1_IN equal to 40-80V in the BOOST mode into the first output voltage U1_OUT equal to 90-100V. The second DC voltage converter 4b is configured or set or designed such that it converts the second input voltage U2_IN equal to 90-100V in the BUCK-BOOST mode into the second output voltage U2_OUT equal to 24V.

FIG. 4 shows a block diagram of the drive 2 according to the invention with the device 1 according to the invention and the battery 9 with a nominal voltage equal to 80V. Here, the first DC voltage converter 4a is configured or set in such a way that it converts the first input voltage U1_IN equal to 40-80V in the BOOST mode into the first output voltage U1_OUT equal to 70-100V. The second DC voltage converter 4b is configured or set or designed in such a way that it converts the second input voltage U2_IN equal to 70-100V in the BUCK-BOOST mode into the second output voltage U2_OUT equal to 24V.

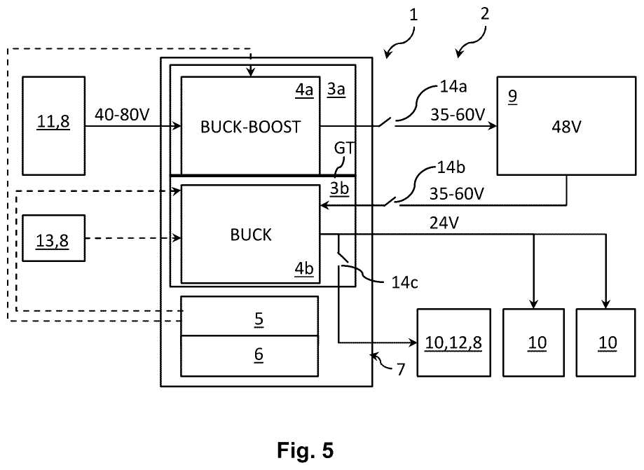

FIG. 5 shows a block diagram of the drive 2 according to the invention with the device 1 according to the invention and the battery 9 with a nominal voltage equal to 48V. Here, the first DC voltage converter 4a is configured or set such that it converts the first input voltage U1_IN equal to 40-80V in the BUCK-BOOST mode into the first output voltage U1_OUT equal to 35-60V. The second DC voltage converter 4b is configured or set or designed such that it converts the second input voltage U2_IN equal to 35-60V in the BUCK-BOOST mode into the second output voltage U2_OUT equal to 24V.

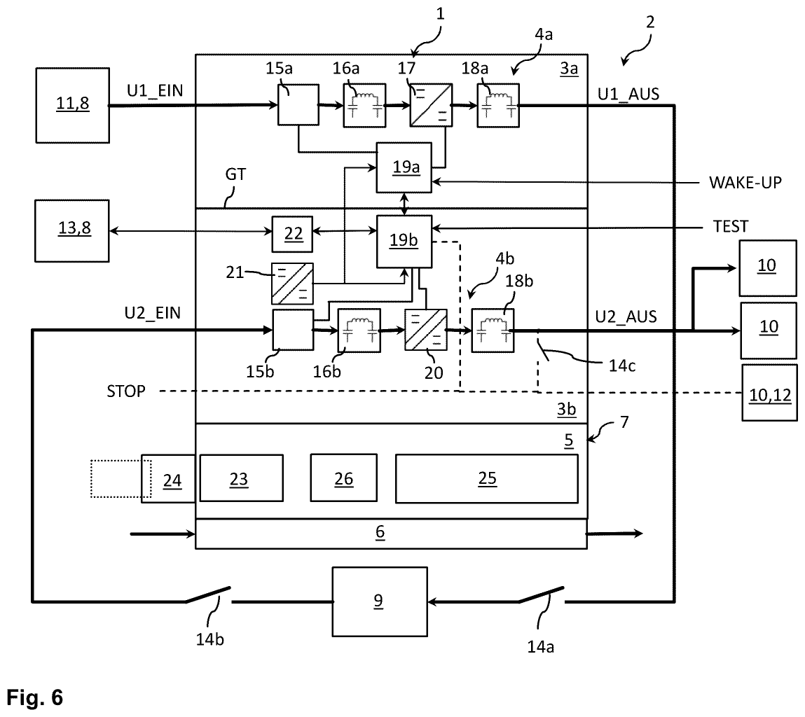

FIG. 6 shows a further block diagram of the drive 2 according to the invention with the device 1 according to the invention. As already described above, the device 1 comprises the first unit 3a with the first DC voltage converter 4a and the second unit 3b with the second DC voltage converter 4b. In FIG. 6, individual electrical and/or signal-transmitting connections are labelled with arrows.

The first unit 3a of the device 1 is electrically connected on the input side to the fuel cell 11 of the fuel cell system 8 and on the output side to the battery 9. The first DC voltage converter 4a converts the first input voltage U1_IN equal to 40-80V provided by the fuel cell 11 of the fuel cell system 8 into the configurable first output voltage U1_OUT equal to 35-100V. The first output voltage U1_OUT provided by the first DC voltage converter 4a depends on the nominal voltage of the battery 9 installed in the drive 2. The battery 9 can have a nominal voltage equal to 48-96V and, in particular, equal to exactly 48V or exactly 80V or exactly 96V. The first DC voltage converter 4a can be set or configured as an inverse converter and as a boost converter and can be operated in the BUCK-BOOST mode and in the BOOST mode.

The first DC voltage converter 4a comprises a precharging circuit 15a, an input filter circuit 16a, a multiphase converter circuit 17 and an output filter circuit 18a. In addition, the first unit 3a comprises a first controller 19a, preferably a microcontroller, for controlling the first DC voltage converter 4a and, in particular, for controlling the multiphase converter circuit 17 by means of a PWM signal. The first unit 3a can be started by means of an external WAKE-UP signal WAKE-UP at the first controller 19a. The WAKE-UP signal WAKE-UP can, for example, be a CAN signal or a hardware signal. The first DC voltage converter 4a or the first unit 3a is electrically connected to the battery 9 via the first circuit breaker 14a. The first circuit breaker 14a can be opened in exceptional operation in the event of danger or a critical situation and the battery 9 can be protected against overvoltage.

The second unit 3b of the device 1 is electrically connected to the battery 9 on the input side and to the elements 10 on the output side. The second DC voltage converter 4b converts the second input voltage U2_IN provided by the battery 9 equal to 35-100V into the second output voltage U2_OUT equal to 24V. The second input voltage U2_IN provided to the second DC voltage converter 4b depends on the nominal voltage of the battery 9 installed in the drive 2. The second DC voltage converter 4b can be operated as a buck converter in BUCK mode.

The second DC voltage converter 4b comprises a precharging circuit 15b, an input filter circuit 16b, a buck converter circuit 20 and an output filter circuit 18b. In addition, the second unit 3b comprises a second controller 19b, preferably a microcontroller, for controlling the second DC voltage converter 4b and, in particular, the buck converter circuit 20. The second DC voltage converter 4b can be controlled by means of the second controller 19b in such a way that, when the second input voltage U2_IN provided by the battery 9 is applied, it immediately starts converting the second input voltage U2_IN into the second output voltage U2_OUT. The function of the second unit 3b can be tested by means of an external test signal TEST at the second controller 19b. In principle, it can be provided that the second DC voltage converter 4b monitors itself as soon as the second input voltage U2_IN is provided. In this case, an external test signal TEST is not required.

The second unit 3b also has a further converter 21. The converter 21 can switch on the second controller 19b during the starting process of the second DC voltage converter 4b and can generate an internal auxiliary voltage. The battery 9 is electrically connected to the second DC voltage converter 4b or to the second unit 3b via the second circuit breaker 14b. The second circuit breaker 14b can be opened in exceptional operation in the event of danger or a critical situation. The second unit 3b is also galvanically isolated from the first unit 3a by means of the galvanic isolation GT.

The second output voltage U2_OUT is provided to the elements 10 of the drive 2. One element 10 is represented by the safety-critical valve 12 of the fuel cell system 8. The safety-critical valve 12 is connected to the second DC voltage converter 4b via the third circuit breaker 14c. If required, the third circuit breaker 14c can be completely deactivated by means of an external signal STOP. The external signal STOP can, for example, be generated by the controller 13 of the fuel cell system 8. Alternatively or additionally, the signal-transmitting connection between the controller 13 and the fuel cell system 8 and the second unit 3b or the second controller 19b of the second unit 3b can be monitored by means of the fuse unit 5. If the signal-transmitting connection is disturbed or interrupted, the second unit 3b can switch off the third circuit breaker 14c by means of an internal STOP signal. The other elements 10 can be sensors or actuators of the drive 2 or the fuel cell system 8. The third circuit breaker 14c is only closed and the safety-relevant valve 12 is accordingly only open if there is a signal-transmitting connection between the controller 13 of the fuel cell system 8 and the second unit 3b or the second controller 19b of the second unit 3b. The signal-transmitting connection between the second unit 3b and the controller 13 of the fuel cell system 8 can be realised by means of a CAN bus 22.

As already described above, the fuse unit 5 can monitor the interlocking between the fuse unit 5 and the first unit 3a. For this purpose, the fuse unit 5 can, for example, monitor by means of a unit 23 for interlock monitoring whether the first unit 3a or the first DC voltage converter 4a is properly connected to the fuse unit 5 via a connection 24. If this is not the case, the fuse unit 5 can set the first output voltage U1_OUT to a value below 60V within 5 seconds. For this purpose, the fuse unit 5 has a resistor chain 26 with several electrical resistors. The fuse unit 5 can also have a unit for temperature monitoring and/or a unit for power monitoring and/or a unit for short-circuit monitoring and/or a unit for overvoltage and undervoltage monitoring and/or a unit for limit current monitoring. In FIG. 6, all of these units are labelled as a common unit 25 for clarity.

The device 1 also comprises the cooling plate 6. The cooling plate 6 allows the cooling fluid to flow through it and can be connected to the first unit 3a and/or to the second unit 3b and/or to the fuse unit 5 heat-transferringly. In particular, this can prevent the first unit 3a and/or the second unit 3b and/or the fuse unit 5 from overheating.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A device (1) for converting voltage for a fuel cell electric drive (2), in particular of a forklift truck,
wherein the device (1) comprises a first unit (3a) with a first DC voltage converter (4a) for converting a first input voltage (U1_IN) provided by a fuel cell system (8) of the drive (2) into a first output voltage (U1_OUT) to be provided to a battery (9) of the drive (2), and
wherein the device (1) has a second unit (3b) with a second DC voltage converter (4b) for converting a second input voltage (U2_IN) provided by the battery (9) of the drive (2) into a second output voltage (U2_OUT) to be provided for operating at least one element (10) of the drive (2),
wherein,
the first DC voltage converter (4a) is designed such that it can be set and operated as an inverse converter or as a boost converter depending on the level of the first output voltage (U1_OUT) to be provided to the battery (9) of the drive (2).

2. The device (1) according to claim 1,
wherein,
the device (1) is designed for the drive (2) with the battery (9) with a nominal voltage equal to 48-96V, and/or
in that the device (1) is designed for the drive (2) with the batteries (9) each having a nominal voltage equal to 96V and 80V and 48V, and/or
in that the first DC voltage converter (4a) is designed to convert the first input voltage (U1_IN) equal to 40-80V into the first output voltage (U1_OUT) equal to 35-100V, and/or
the second DC voltage converter (4b) is designed to convert the first input voltage (U2_IN) equal to 35-100V into the second output voltage (U2_OUT) equal to 24V.

3. The device (1) according to claim 1,
wherein,
the first DC voltage converter (4a) is designed to convert the first input voltage (U1_IN) equal to 40-80V into the first output voltage (U1_OUT), and/or
the device (1) is designed for the drive (2) with the battery (9) with a nominal voltage equal to 96V and the first DC voltage converter (4a) is set as a step-up converter for converting the first input voltage (U1_IN) into the first output voltage (U1_OUT) equal to 90-100V, and/or
in that the device (1) is designed for the drive (2) with the battery (9) with a nominal voltage equal to 80V and the first DC voltage converter (4a) is set as a step-up converter for converting the first input voltage (U1_IN) into the first output voltage (U1_OUT) equal to 70-100V, and/or
the device (1) is designed for the drive (2) with the battery (9) with a nominal voltage equal to 48V and the first DC voltage converter (4a) is set as an inverse converter for converting the first input voltage (U1_IN) into the first output voltage (U1_OUT) equal to 35-60V.

4. The device (1) according to claim 1,
wherein,
the second DC voltage converter (4b) is designed to convert the second input voltage (U2_IN) into the second output voltage (U2_OUT) equal to 24V, and/or
in that the device (1) is designed for the drive (2) with the battery (9) with a nominal voltage equal to 96V and the second DC voltage converter (4b) is designed as a step-down converter for converting the second input voltage (U2_IN) equal to 90-100V into the second output voltage (U2_OUT) equal to 24V, and/or
the device (1) is designed for the drive (2) with the battery (9) with a nominal voltage equal to 80V and the second DC voltage converter (4b) is designed as a step-down converter for converting the second input voltage (U2_IN) equal to 70-100V into the second output voltage (U2_OUT) equal to 24V, and/or
the device (1) is designed for the drive (2) with the battery (9) with a nominal voltage equal to 48V and the second DC voltage converter (4b) is designed as a step-down converter for converting the second input voltage (U2_IN) equal to 35-60V into the second output voltage (U2_OUT) equal to 24V.

5. The device (1) according to claim 1,
wherein,
the first unit (3a) comprises a first controller (19a), preferably a microcontroller, for controlling the first DC voltage converter (4a), and the first DC voltage converter (4a) can be set and operated as an inverse converter or as a boost converter by means of the first controller (19a), and/or
the first unit (3a) comprises a first controller (19a), preferably a microcontroller, for controlling the first DC voltage converter (4a), and the first DC voltage converter (4a) can be operated in a constant-current mode or in a constant-voltage mode by means of the first controller (19a), and/or
the second unit (3b) comprises a second controller (19b), preferably a microcontroller, for controlling the second DC voltage converter (4b), and/or
in that the second unit (3b) comprises a second controller (19b), preferably a microcontroller, for controlling the second DC voltage converter (4b) and the second DC voltage converter (4b) can be controlled by means of the second controller (19b) in such a way that, when the second input voltage (U2_IN) is applied, it immediately starts converting the second input voltage (U2_IN) into the second output voltage (U2_OUT).

6. The device (1) according to claim 1,
wherein,
the device (1) comprises a housing (7) and the first unit (3a) and the second unit (3b) and/or the first DC voltage converter (4a) and the second DC voltage converter (4b) are arranged together in the housing (7), and/or
the first unit (3a) and the second unit (3b) and/or the first DC voltage converter (4a) and the second DC voltage converter (4b) are mapped on a common printed circuit board,
and/or
the first unit (3a) and the second unit (3b) and/or the first DC voltage converter (4a) and the second DC voltage converter (4b) are galvanically isolated from each other.

7. The device (1) according to claim 1,
wherein,
the first DC voltage converter (4a) comprises a precharging circuit (15a) and/or an input filter circuit (16a) and/or a multiphase converter circuit (17) which can be controlled by a first controller (19a) by means of a PWM signal and/or an output filter circuit (18a),
and/or
the second DC voltage converter (4b) comprises a precharging circuit (15b) and/or an input filter circuit (16b) and/or a buck converter circuit (20) and/or an output filter circuit (18b).

8. The device (1) according to claim 1,
wherein,
the device (1) comprises a first circuit breaker (14a) and the first circuit breaker (14a) is connected directly downstream of the first DC voltage converter (4a) and/or the first unit (3a), the first circuit breaker (14a) being closed during normal operation of the device (1) and being open during exceptional operation of the device (1), and/or
the device (1) comprises a second circuit breaker (14b) and the second circuit breaker (14b) is connected directly upstream of the second DC voltage converter (4b) and/or the second unit (3b), the second circuit breaker (14b) being closed during normal operation of the device (1) and open during exceptional operation of the device (1).

9. The device (1) according to claim 1,
wherein,
the second unit (3b) and/or the second DC voltage converter (4b) comprises a third circuit breaker (14c) for switching on and off at least one safety-relevant element (10) of the drive (2), preferably a safety-relevant valve (12) of the fuel cell system (8),
in that the third circuit breaker (14c) is designed in such a way that in normal operation,
when a signal-transmitting connection is present between a controller (13) controlling the fuel cell system (8) of the drive (2) and the second unit (3b), the third circuit breaker (14c) is closed and the respective element (10) is switched on, and
the third circuit breaker (14c) is designed such that, in exceptional operation, if there is no signal-transmitting connection between the controller (13) controlling the fuel cell system (8) of the drive (2) and the second unit (3b), the third circuit breaker (14c) is opened and the respective element (10) is switched off.

10. The device (1) according to claim 1,
wherein,
the device (1) comprises a fuse unit (5) for monitoring the operation of the first unit (3a) and/or the second unit (3b) with a unit for temperature monitoring and/or with a unit for power monitoring and/or with a unit for short-circuit monitoring and/or with a unit for overvoltage and undervoltage monitoring and/or with a unit for limit current monitoring and/or with a unit (23) for interlock monitoring between the fuse unit (5) and the first unit (3a) and/or the second unit (3b).

11. The device (1) according to claim 1,
wherein,
the device (1) comprises a cooling plate (6) through which a cooling fluid can flow, and
the cooling plate (6) is connected to the first unit (3a) and/or to the second unit (3b) and/or to a fuse unit (5) for monitoring the operation of the first unit (3a) and/or the second unit (3b) heat-transferringly.

12. A fuel cell electric drive (2), in particular of a forklift truck,
wherein the drive (2) comprises a fuel cell system (8), a battery (9), at least one electrical element (10) and the device (1) according claim 1,
wherein the fuel cell system (8), the battery (9), the respective electrical element (10) and the device (1) are electrically interconnected in such a way that
1. the first input voltage (U1_IN) for the first DC voltage converter (4a) of the device (1) can be provided by the fuel cell system (8),
2. the first output voltage (U1_OUT) of the first DC voltage converter (4a) of the device (1) can be provided for charging the battery (9),
3. the second input voltage (U2_IN) for the second DC voltage converter (4b) of the device (1) can be provided by the battery (9), and
4. the second output voltage (U2_OUT) of the second DC voltage converter (4b) of the device (1) can be provided for operating the respective electrical element (10).
